(19) United States
(12) Patent Application Publication
(10) Pub. No.: US 2017/0244975 A1
(43) Pub. Date: Aug. 24, 2017

(54) Method of Guided Cross-Component Prediction for Video Coding

(71) Applicant: MediaTek Singapore Pte. Ltd., Singapore (SG)

(72) Inventors: Han HUANG, Beijing (CN); Kai ZHANG, Beijing (CN); Xianguo ZHANG, Beijing (CN)

(21) Appl. No.: 15/519,181

(22) PCT Filed: Oct. 19, 2015
(86) PCT No.: PCT/CN2015/092168

§ 371 Date: Apr. 14, 2017

(30) Foreign Application Priority Data
Oct. 28, 2014 (CN) PCT/CN2014/089716
Jan. 23, 2015 (CN) PCT/CN2015/071440

(51) Int. Cl. H04N 19/186; H04N 19/61; H04N 19/513

(52) U.S. Cl. CPC H04N 19/186; H04N 19/513; H04N 19/61

(57) ABSTRACT

A method of cross-component residual prediction for video data comprising two or more components is disclosed. First prediction data and second prediction data for a first component and a second component of a current block are received respectively. One or more parameters of a cross-component function are derived based on the first prediction data and the second prediction data. The cross-component function is related to the first component and the second component with the first component as an input of the cross-component function and the second component as an output of the cross-component function. A residual predictor is derived for second residuals of the second component using the cross-component function with first reconstructed residuals of the first component as the input of the cross-component function. The predicted difference between the second residuals of the second component and the residual predictor is encoded or decoded.

### CROSS REFERENCE TO RELATED APPLICATIONS

The present invention claims priority to PCT Patent Application, Serial No. PCT/CN2014/089716, filed on Oct. 28, 2014 and PCT Patent Application, Serial No. PCT/CN2015/071440, filed on Jan. 23, 2015. The PCT Patent Applications are hereby incorporated by reference in their entireties.

### TECHNICAL FIELD

The present invention relates to video coding. In particular, the present invention relates to coding techniques associated with cross-component residual prediction for improving coding efficiency.

### BACKGROUND

Motion compensated Inter-frame coding has been widely adopted in various coding standards, such as MPEG-1/2/4 and H.261/H.263/H.264/AVC. While motion-compensated Inter-frame coding can effectively reduce bitrate for compressed video, intra coding is required to compress the regions with high motion or scene changes. Besides, intra coding is also used to process an initial picture or to periodically insert I-pictures or I-blocks for random access or for alleviation of error propagation. Intra prediction exploits the spatial correlation within a picture or within a picture region. In practice, a picture or a picture region is divided into blocks and the intra prediction is performed on a block basis. Intra prediction for a current block can rely on pixels in neighboring blocks that have been processed. For example, if blocks in a picture or picture region are processed row by row first from left to right and then from top to bottom, neighboring blocks on the top and neighboring blocks on the left of the current block can be used to form intra prediction for pixels in the current block. While any pixels in the processed neighboring blocks can be used for intra predictor of pixels in the current block, very often only pixels of the neighboring blocks that are adjacent to the current block boundaries on the top and on the left are used.

The intra predictor is usually designed to exploit spatial features in the picture such as smooth area (DC mode), vertical line or edge, horizontal line or edge and diagonal line or edge. Furthermore, cross-components correlation often exists between the luminance (luma) and chrominance (chroma) components. Therefore, cross-component prediction estimates the chroma samples by linear combination of the luma samples, as shown in equation (1),

P_{c}=α·P_{L}+β (1)

where P_{C} and P_{L}, represent chroma samples and luma samples respectively, and α and β are two parameters.

During the development of High Efficiency Video Coding (HEVC), a chroma intra prediction method based on co-located reconstructed luma blocks has been disclosed (Chen, et al., “Chroma intra prediction by reconstructed luma samples”, Joint Collaborative Team on Video Coding (JCT-VC) of ITU-T SG16 WP3 and ISO/IEC JTC1/SC29/WG1 3rd Meeting: Guangzhou, CN, 7-15 Oct. 2010, Document: JCTVC-C206). The type of chroma intra prediction is termed as LM prediction. The main concept is to use the reconstructed luma pixels to generate the predictors of corresponding chroma pixels. FIG. 1A and FIG. 1B illustrate the prediction procedure. First, the neighboring reconstructed pixels of a co-located luma block in FIG. 1A and the neighboring reconstructed pixels of a chroma block in FIG. 1B are used to derive the correlation parameters between the blocks. Then, the predicted pixels of the chroma block (i.e., Pred_{C}[x, y]) are generated using the parameters and the reconstructed pixels of the luma block (i.e., Rec_{L}[x, y]) as shown in equation (2),

Pred_{C}[x, y]=α·Rec_{L}[x, y]+β. (2)

In the parameters derivation, the first above reconstructed pixel row and the second left reconstructed pixel column of the current luma block are used. The specific row and column of the luma block are used in order to match the 4:2:0 sampling format of the chroma components.

Along with the High Efficiency Video Coding (HEVC) standard development, the development of extensions of HEVC has started. The HEVC extensions include range extensions (RExt) which target at non-4:2:0 color formats, such as 4:2:2 and 4:4:4, and higher bit-depths video such as 12, 14 and 16 bits per sample. A coding tool developed for RExt is Inter-component prediction that improves coding efficiency particularly for multiple color components with high bit-depths. Inter-component prediction can exploit the redundancy among multiple color components and improves coding efficiency accordingly. A form of Inter-component prediction being developed for RExt is Inter-component Residual Prediction (IRP) as disclosed by Pu et al. in JCTVC-N0266, (“Non-RCE1: Inter Color Component Residual Prediction”, in Joint Collaborative Team on Video Coding (JCT-VC) of ITU-T SG 16 WP 3 and ISO/IEC JTC 1/SC 29/WG 11, 14th Meeting: Vienna, AT, 25 Jul.-2 Aug. 2013 Document: JCTVC-N0266).

In Inter-component Residual Prediction, the chroma residual is predicted at the encoder side as:

r_{C}′(x, y)=r_{C}(x, y)−(α×r_{L}(x, y)). (3)

In equation (3), r_{C}(x, y) denotes the final chroma reconstructed residual sample at position (x, y), r_{C}′(x, y) denotes the reconstructed chroma residual sample from the bit-stream at position (x, y), r_{L}(x, y) denotes the reconstructed residual sample in the luma component at position (x, y) and α is a scaling parameter (also called alpha parameter, or scaling factor). Scaling parameter α is calculated at the encoder side and signaled. At the decoder side, the parameter is recovered from the bitstream and the final chroma reconstructed residual sample is derived according to equation (4):

r_{C}′(x, y)=r_{C}′(x, y)+(α×r_{L}(x, y)). (4)

While the YUV format is used as an example to illustrate Inter-component residual prediction derivation, any other color format may be used. For example, RGB format may be used. If R component is encoded first, R component is treated the same way as the luma component in the above example. Similarly, if G component is encoded first, the G component is treated the same way as the luma component.

An exemplary decoding process for the IRPin the current HEVC-RExt is illustrated in FIG. 2 for transform units (TUs) of the current unit (CU). The decoded coefficients of all TUs of a current CU are provided for multiple components. For the first component (e.g., Y component), the decoded transform coefficients are inverse transformed (block 210) to recover the Intra/Inter coded residual of the first color component. The Inter/Intra coded first color component is then processed by First Component Inter/Intra Compensation 220 to produce the final reconstructed first component. The needed Inter/Intra reference samples for First Component Inter/Intra Compensation 220 are provided from buffers or memories. In FIG. 2, it implies that the first color component is Inter/Intra coded so that the Inter/Intra compensation is used to reconstruct the first component from the reconstructed residual. For the second color component, the decoded transform coefficients are decoded using second component decoding process (block 212) to recover Inter-component coded second component. Since the second component is Inter-component residual predicted based on the first component residual, Inter-component Prediction for second Component (block 222) is used to reconstruct the second component residual based on outputs from block 210 and block 212. As mentioned before, the Inter-component residual prediction needs the scaling parameter coded. Therefore, decoded alpha parameter between the first color component and the second color component is provided to block 222. The output from block 222 corresponds to Inter/Intra prediction residual of the second component. Therefore, second Component Inter/Intra Compensation (block 232) is used to reconstruct the final second component. For the third component, similar processing can be used (i.e., blocks 214, 224 and 234) to reconstruct the final third component. According to the decoding process, the encoding process can be easily derived.

It is desirable to develop techniques to further improve the coding efficiency associated with inter-component residual prediction.

### SUMMARY

A method of cross-component residual prediction for video data comprising two or more components is disclosed. According to the present invention, first prediction data and second prediction data for a first component and a second component of a current block are received respectively. One or more parameters of a cross-component function are derived based on the first prediction data and the second prediction data. The cross-component function is related to the first component and the second component with the first component as an input of the cross-component function and the second component as an output of the cross-component function. A residual predictor is derived for second residuals of the second component using the cross-component function with first reconstructed residuals of the first component as the input of the cross-component function, where the second residuals of the second component correspond to a second difference between original second component and the second prediction data. The predicted difference between the second residuals of the second component and the residual predictor is encoded or decoded.

The first prediction data and the second prediction data may correspond to motion compensation prediction blocks, reconstructed neighboring samples, or reconstructed neighboring residuals of the current block for the first component and the second component respectively. The motion compensation prediction blocks of the current block for the first component and the second component correspond to Inter,

Inter-view or Intra Block Copy predictors of the current block for the first component and the second component respectively. The video data may have three components corresponding to YUV, YCrCb or RGB, and the first component and the second component are selected from the three components. For example, when the three components correspond to YUV or YCrCb, the first component may correspond to Y and the second component may correspond to one chroma component selected from UV or CrCb. In another example, the first component may correspond to a first chroma component selected from UV or CrCb and the second component corresponds to a second chroma component selected from UV or CrCb respectively.

The cross-component function may correspond to a linear function comprising an alpha parameter or both an alpha parameter and a beta parameter, where the alpha parameter corresponds to a scaling term to multiply with the first component and the beta parameter corresponds to an offset term. The parameters can be determined using a least square procedure based on the cross-component function with the first prediction data as the input of the cross-component function and the second prediction data as the output of the cross-component function. The first prediction data and the second prediction data may correspond to motion compensation prediction blocks, reconstructed neighboring samples, or reconstructed neighboring residuals of the current block for the first component and the second component respectively.

One aspect of the present invention addresses the issue of different spatial resolution between the first component and the second component. If the first component has a finer spatial resolution than the second component, the first prediction data can be subsampled to a same spatial resolution of the second component. For example, the first component has N fist samples and the second component has M second samples with N>M. When the first prediction data and the second prediction data correspond to the reconstructed neighboring samples or the reconstructed neighboring residuals of the current block for the first component and the second component respectively, an average value of every two reconstructed neighboring samples or reconstructed neighboring residuals of the current block for the first component can be used for deriving the alpha parameter, the beta parameter or both of the alpha parameter and the beta parameter if M is equal to N/2. When the first prediction data and the second prediction data correspond to the predicted samples of the motion compensation prediction blocks of the current block for the first component and the second component respectively, an average value of every two vertical-neighboring predicted samples of the motion compensation prediction block of the current block for the first component can be used for deriving the parameters if M is equal to N/2. When the first prediction data and the second prediction data correspond to the predicted samples of the motion compensation prediction blocks of the current block for the first component and the second component respectively, an average value of left-up and left-down samples of every four-sample cluster of the motion compensation prediction block of the current block for the first component can be used for deriving the parameters if M is equal to N/4.

For parameter derivation, the first prediction data and the second prediction data may correspond to subsampled or filtered motion compensation prediction blocks of the current block for the first component and the second component respectively. The parameters can be determined and transmitted for each PU (prediction unit) or CU (coding unit). The parameters can be determined and transmitted for each TU (transform unit) in each Intra coded CU, and for each PU or CU in each Inter or Intra Block Copy coded CU. The cross-component residual prediction can be applied to each TU in each Intra coded CU, and to each PU or CU in each Inter, inter-view or Intra Block Copy coded CU. A mode flag to indicate whether to apply the cross-component residual prediction can be signaled at TU level for each Intra coded CU, and at PU or CU level for each Inter, inter-view or Intra Block Copy coded CU.

When the first component has a higher spatial resolution than the second component, the subsampling techniques mentioned for parameter derivation can also be applied to deriving the residual predictor for second residuals of the second component. For example, when the first reconstructed residuals of the first component consist of N first samples and the second residuals of the second component consist of M second samples with M equal to N/4, an average value of left-up and left-down samples of every four-sample cluster of the first reconstructed residuals of the first component can be used for the residual predictor. The average value of every four-sample cluster, average value of two horizontal neighboring samples of every four-sample cluster or a corner sample of every four-sample cluster of the first reconstructed residuals of the first component can also be used for the residual predictor.

### BRIEF DESCRIPTION OF DRAWINGS

FIG. 1A illustrates an example of derivation of chroma intra prediction based on reconstructed luma pixels according to the High Efficiency Video Coding (HEVC) range extensions (RExt).

FIG. 1B illustrates an example of neighboring chroma pixels and chroma pixels associated with a corresponding chroma block to be predicted according to the High Efficiency Video Coding (HEVC) range extensions (RExt).

FIG. 2 illustrates an example of decoding process for the IRP (Inter-component Residual Prediction) in the High Efficiency Video Coding (HEVC) range extensions (RExt) for transform units (TUs) of the current unit (CU).

FIG. 3 illustrates an exemplary system structure of guided cross-component residual prediction according to the present invention.

FIG. 4 illustrates an exemplary system structure for parameter derivation based on reconstructed neighboring samples according to an embodiment of the present invention.

FIG. 5 illustrates an exemplary system structure for parameter derivation based on an average value of left-up and left-down samples of every four-sample cluster of reconstructed prediction samples according to an embodiment of the present invention.

FIG. 6A illustrates an exemplary system structure for parameter derivation based on a corner sample of every four-sample cluster of reconstructed prediction samples according to an embodiment of the present invention.

FIG. 6B illustrates an exemplary system structure for parameter derivation based on an average value of two horizontal samples of every four-sample cluster of reconstructed prediction samples according to an embodiment of the present invention.

FIG. 6C illustrates an exemplary system structure for parameter derivation based on an average value of every four-sample cluster of reconstructed prediction samples according to an embodiment of the present invention.

FIG. 7 illustrates an exemplary flowchart for guided cross-component residual prediction incorporating an embodiment of the present invention.

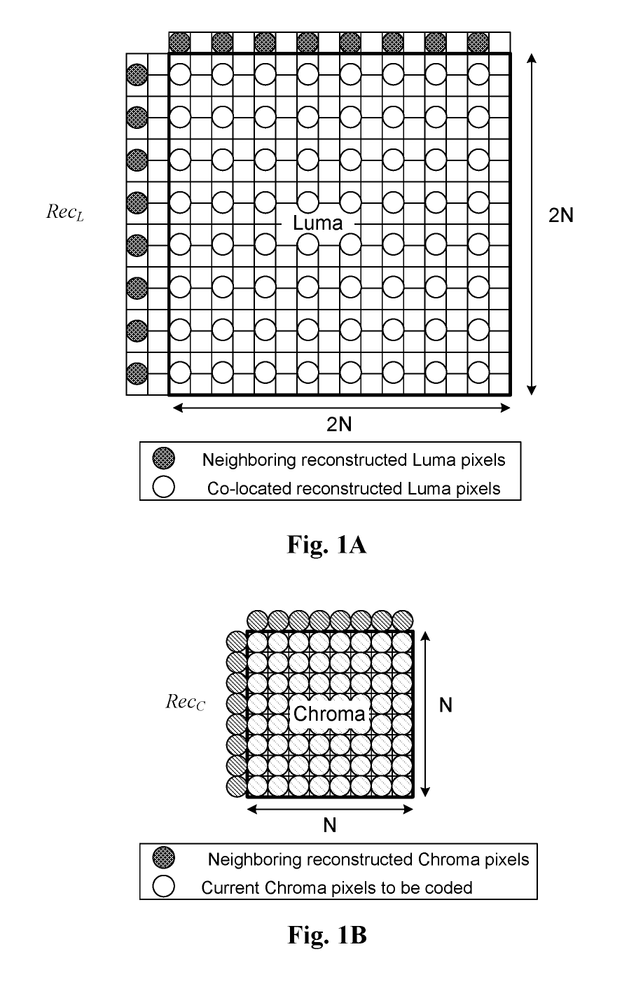

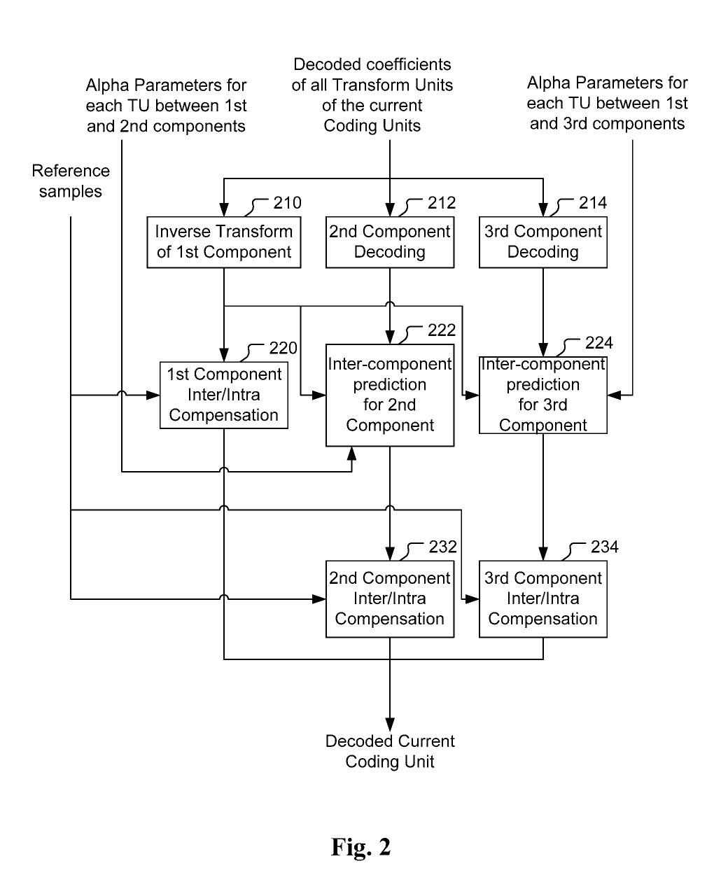

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

As mentioned before, the inter-component prediction as disclosed in JCTVC-C206 is limited to Intra chroma coding. Furthermore, the parameter derivation is based on the reconstructed neighboring samples of the luma and chroma blocks. On the other hand, JCTVC-N0266 discloses inter-component residual prediction for Intra and Inter coded blocks and the alpha parameter is always derived at the encoder side and transmitted in the video stream. According to the HEVC standard, the alpha parameter is transmitted and there is no need to derive the parameter at the decoder side. Furthermore, the HEVC standard also adopts IRP for video data at 4:4:4 format. However, IRP can also improve coding efficiency for video data at other formats such as 4:2:0 format. When IRP is extended to the 4:2:0 format, issues related to how to determine the correspondence between luma and the current chroma samples, parameter derivation and predictor generation are yet to be addressed. Accordingly, various techniques to improve IRP coding efficiency are disclosed in this application.

While the conventional IRP process includes parameter derivation and predictor generation at the TU (i.e., transform unit) level, IRP may also be applied to the CU (i.e., coding unit) or PU (i.e., prediction unit), where IRP is more effective due to the smaller overhead produced for signaling this mode and parameter transmission. Furthermore, the IRP adopted by HEVC only utilizes reconstructed luma residuals to predict the current chroma residuals. However, it is also feasible to utilize reconstructed non-first chroma residuals to predict the current chroma residuals. As mentioned before, the existing LM mode is not flexible and the method is not efficient when the chroma pixels do not correspond to the 4:2:0 sampling format, where the LM mode refers to the Intra chrome prediction that utilizes the co-located reconstructed luma block as a predictor.

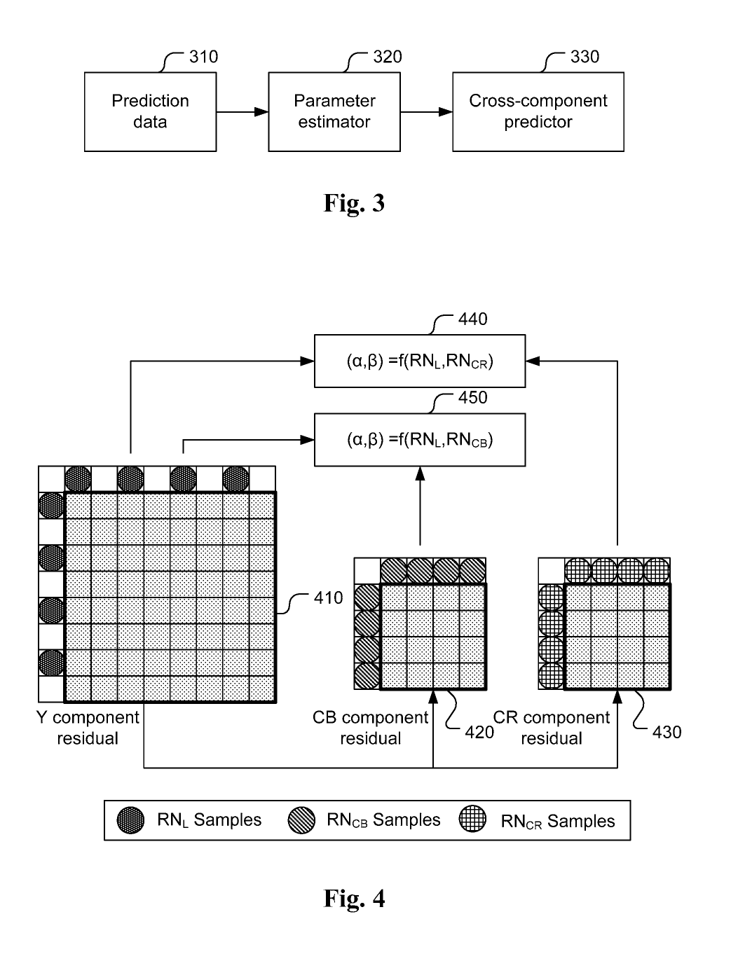

Accordingly, embodiments based on the present invention provide flexible LM-based chroma Intra prediction that supports different chroma sampling formats adaptively. FIG. 3 illustrates a basic structure of inter-component residual prediction according to the present invention. The prediction data 310 is used to derive a set of parameters at the parameter estimator 320. The parameters are then used for cross-component predictor 330 of the current block. In this disclosure, the terms inter-component and cross-component are used interchangeably. According to the coding structure in FIG. 3, the prediction data is used as a guide for coding of the current block, where the prediction data may correspond to the prediction block as used by conventional prediction coding. For example, the prediction data may correspond to the reference block (i.e., the motion compensation prediction block) in Inter coding. However, other prediction data may also be used. The system according to the present invention is termed as guided inter-component prediction.

Assume that a linear function can be used to model the relationship between two components P_{X} and P_{Z}, i.e. the relationship can be represented by equation (5),

P_{X}=α·P_{Z}+β(5)

for both prediction signals(Pred_{X} and Pred_{Z}) and reconstructed signals (Reco_{X} and Reco_{Z}). In other words, the following relations hold:

Pred_{X}−α·Pred_{Z}+β, (6)

and

Reco_{X}−α·Reco_{Z}|β. (7)

Accordingly, the difference between the reconstructed and the prediction signals for component X can be determined according to equation (8) by substituting the prediction and reconstructed signals in equations (6) and (7):

Reco_{X}−Pred_{X}=α·(Reco_{X}−Pred_{X}), i.e., Resi_{X}=α·Resi_{Z}, (8)

where Resi_{X} is residual signal for component X and Resi_{Z} is residual signal for component Z. Therefore, if a function (i.e., f(Resi_{Z}) of residual signal for component Z is used to predict the residual for component X, the function can be represented as: f(Resi_{Z})=α·Resi_{Z}.

In one embodiment, the residuals of component X to be coded can be calculated as:

Resi_{X}′=Resi_{X}−f(Resi_{Z}), (9)

where the residual signal (i.e., Resi_{X}) for component X corresponds to the difference between the original signal (i.e., Orig_{X}) and the prediction signal (i.e., Pred_{X}), and Resi_{Z} is the reconstructed residual signal for component Z. Resi_{X} is derived as shown in equation (10):

Resi_{X}=Orig_{X}−Pred_{X}. (10)

At the decoder side, the reconstructed signal for component X is calculated according to Pred_{X}+Resi_{X}′+f(Resi_{Z}). Component Z is coded or decoded before component X at the encoder side or the decoder side respectively. The function f can be derived by analyzing Pred_{X} and Pred_{Z}, where Pred_{X} and Pred_{Z} are the prediction signals for component X and component Z respectively.

In another embodiment, the least square procedure can be used to estimate the parameters by minimizing the mean square error according to Pred_{X}=α·Pred_{Z}+β.

The subsampled prediction block can be used for parameter estimation. For example, the prediction data may correspond to the luma component of YUV 4:2:0 format and the current component may correspond to a chroma component. In this case, subsampling can be applied to the luma prediction signal. However, subsampling may also be applied to the case where two components have the same spatial resolution. In this case, subsample can reduced required computations to estimate the parameters.

The parameter estimation may also be based on the prediction signal corresponding to the filtered motion compensation prediction block. The filter can be a smooth filter.

In one embodiment, when component Z has a higher resolution than component X, sub sampled component Z can be used for parameter estimation.

In another embodiment, a flag can be coded to indicate whether the inter-component residual prediction is applied. For example, the flag is signaled at CTU (coding tree unit), LCU(largest coding unit), CU (coding unit) level, PU (prediction unit) level, sub-PU or TU (transform unit) level. The flag can be coded for each predicted inter-component individually or only one flag is coded for all predicted inter-components. In still another embodiment, the flag is only coded when the residual signal of component Z is significant, i.e., at least one non-zero residual of component Z. In still another embodiment, the flag is inherited from merge mode. When current block is coded in merge mode, the flag is derived based on its merge candidate so that the flag is not explicit coded.

The flag indicating whether to apply the inter-component residual prediction may also be inherited from the reference block referred by the motion vector (MV), disparity vector (DV) or Intra Block Copy (IntraBC) displacement vector (BV). Let (x, y) be the location of the top-left sample of current block, W and H be the width and height of the current block, and (u,v) be the motion vector or displacement vector, then the reference block is located at (x+u, y+v) or (x+W/2+u, y+H/2+v).

The quantization parameter (QP) for chroma component can be increased by N when chroma inter-component residual prediction is applied. N can be 0, 1, 2, 3, or any other predefined integer numbers. N can also be coded at SPS (sequence parameter set), PPS (picture parameter set), VPS (video parameter set), APS (application parameter set) or slice header, et al.

The guided cross-component residual prediction disclosed above can be applied in CTU (coding tree unit), LCU (largest coding unit), CU (coding unit) level, PU (prediction unit) level, or TU (transform unit) level.

The flag indicating whether to apply the guided inter-component residual prediction can be signaled at CTU, LCU, CU, PU, sub-PU, or TU level accordingly. Furthermore, the flag indicating whether to apply the guided inter-component residual prediction can be signaled at CU level. However, the guided inter-component residual prediction may also be applied at PU, TU or sub-PU level.

Component X and component Z can be selected from any color space. The color space may correspond to (Y, U, V), (Y, Cb, Cr), (R, G, B) or other color spaces. For example, X may correspond to Cb and Z may correspond to Y. In another example, X may correspond to Cr and Z may correspond to Y. In still another example, X may correspond to Y and Z may correspond to Cb. In still another example, X may correspond to Y and Z may correspond to Cr. In still another example, X may correspond to Y and Z may correspond to Cb and Cr.

The guided inter-component residual prediction method can be applied for different video formats, such as YUV444, YUV420, YUV422, RGB, BGR, et al.

While a specific linear model as shown in equation (1) is illustrated, other linear models may also be applied. Beside the reconstructed neighboring sample of co-located block, the reconstructed prediction block can also be used for parameters estimation. For example, the reconstructed prediction block may correspond to reference block in Inter coding, inter-view coding or IntraBC coding, where the reconstructed prediction block represents the motion compensation block located according to a corresponding motion vector in Inter coding, a displacement vector in inter-view coding or a block vector in IntraBC coding.

While a least square based method is used as an example to estimate parameters, other parameter estimation methods can also be adopted instead.

In one embodiment, not only the alpha parameter is used, but also the beta (also namely offset or β) parameter is used to derive the inter-component residual predictor according to r_{C}(x, y)=r_{C}′(x, y)+(α·r(x, y)+β), where r(x, y) may correspond to a reconstructed residual luma component, r_{L}(x, y) or the reconstructed residual block of another chroma component.

The parameter α can be transmitted in the bitstream when inter-component residual prediction is utilized. The parameter β can be transmitted in the bitstream using one or more additional flags when inter-component residual prediction is utilized.

In another embodiment, the required parameters can be derived from the reconstructed neighboring samples, the reconstructed residuals of the neighboring samples or the predicted samples of the current block.

For example, the parameters can be derived at the decoder side using the reconstructed neighboring samples or the reconstructed residuals of neighboring samples of the current block according to (α, β)=f(RN_{L}, RN_{Cb}), (α,β)=f(RN_{L}, RN_{Cr}), or (α, β)=f(RN_{Cb},RN_{Cr}), where RN_{L} can be the reconstructed luma neighboring samples or the reconstructed residuals of luma neighboring samples, RN_{Cb} can be the neighboring reconstructed first chroma-component samples or the neighboring reconstructed residuals of first chroma-component samples, and RN_{Cr} can be the neighboring reconstructed second chroma-component samples or the neighboring reconstructed residuals of second chroma-component samples. FIG. 4 illustrates an example of parameter derivation according to an embodiment of the present invention, where (α, β) is derived based on residuals of the Y component (410) and the Cr component (430) in block 440 and (α, β)is derived based on residuals of the Y component(410) and the Cb component (420) in block 450.

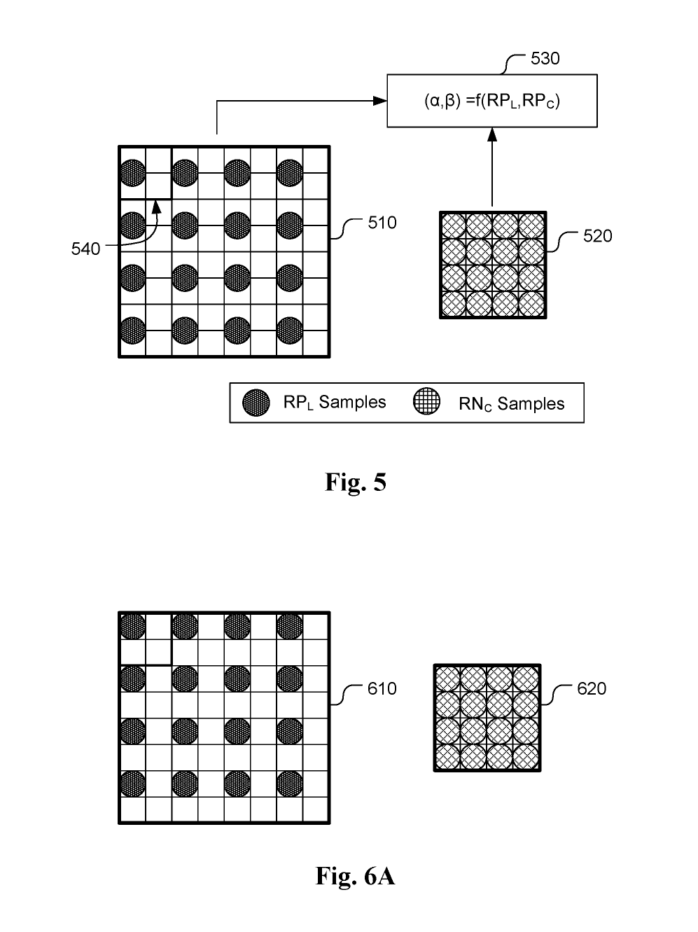

In another example, the parameters can be derived at decoder by the predicted pixels of the current block according to (α, β)=f(RP_{L}, RP_{Cb}), (α, β)=f(RP_{L}, RP_{Cr}), or (α, β)=f(RP_{Cb}, RP_{Cr}), where RP_{L} corresponds to samples of the predicted luma block, RP_{Cb} corresponds to samples of the predicted Cb block and RP_{Cr} corresponds to samples of the predicted Cr block. FIG. 5 illustrates an example of parameter derivation (530) according to an embodiment of the present invention, where (α, β)is derived based on the predicted Y component in block 510 and the predicted C (Cr or Cb) components in block 520.

In another example, the guided inter-component residual prediction is applied to non-4:4:4 video signals. The luma component is down sampled to have the same resolution as the chroma components for parameters derivation and predictor generation.

For example, when there are N luma samples with M (M<N) corresponding chroma samples, one down-sampling operation is conducted to select or generate M luma samples for the parameter derivation.

In another example of the parameter derivation process, the N luma samples correspond to N reconstructed neighboring luma samples of the co-located luma block and M (M<N) chroma samples correspond to M reconstructed neighboring chroma samples of the current chroma block. One down-sampling operation can be used to select or generate M luma samples for the parameter derivation.

In yet another example of the parameter derivation process, during down-sampling N luma neighboring samples to generate M samples with M equal to N/2, the average values of every two luma neighboring samples are selected. The example in FIG. 4 corresponds to the case of down-sampling the N luma neighboring samples to generate M samples with M equal to N/2.

In yet another example of the parameter derivation process, during down-sampling N predicted luma samples to generate M samples with M equal to N/2, the average values of every two vertical-neighboring luma samples are selected.

In yet another example of the parameter derivation process, during down-sampling the N predicted luma samples to generate M samples with M equal to N/4, the average values of left-up and left-down samples of every four-sample cluster (540) are selected. The example in FIG. 5 corresponds to the case of down-sampling the N predicted luma samples to generate M samples with M equal to N/4 by using the average of left-up same and left-down sample of the four-sample cluster.

In another example, when there are a total of N luma samples for the reference block with only M (M<N) to-be-generated predicted samples for the current chroma block, one down-sampling operation can be conducted to select or generate M luma samples for the predictor generation.

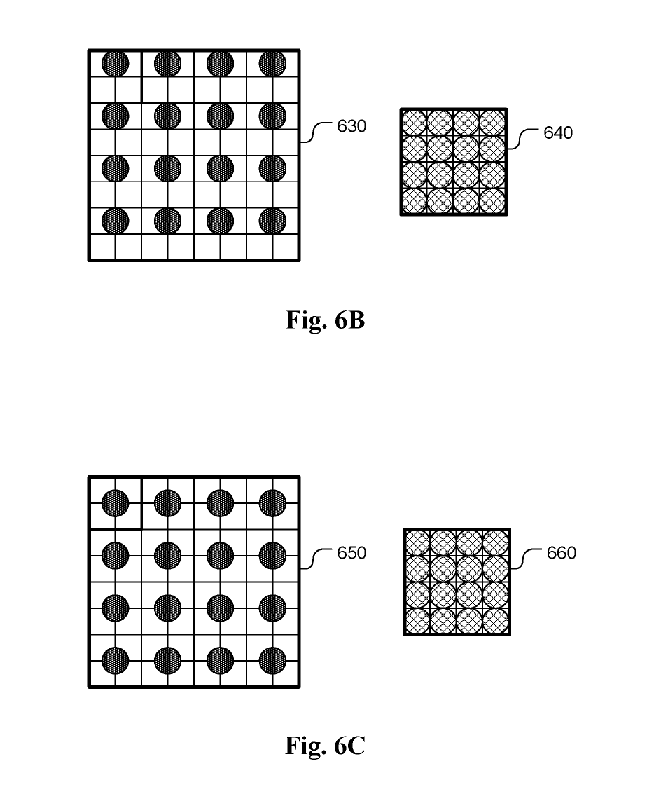

In yet another embodiment of the present invention, for either the parameter derivation process or predictor generation process, down-sampling N luma samples to generate M samples may be based on 4-point-average, corner-point selection, or horizontal-average. FIGS. 6A-C illustrates examples according to this embodiment. In FIG. 6A, the down-sampling process selects the left-up corner sample of every four-sample cluster of the luma block (610) to generate the desired resolution as the chroma block (620). FIG. 6B illustrates an example of using the average of two upper horizontal samples of every four-sample cluster of the luma block (630) as the selected sample to generate the desired resolution as the chroma block (640). FIG. 6C illustrates an example of using the four-point average of every four-sample cluster of the luma block (650) as the selected sample to generate the desired resolution as the chroma block (660).

The parameter derivation process and the predictor generation process may use the same down-sampling process.

In yet another embodiment, parameter estimation and inter-component residual prediction are applied to the current chroma block at the PU (prediction unit) or CU (coding unit) level. For example, each PU or each CU in Inter, inter-view or Intra Block Copy coded CU.

For example, the inter-component residual prediction mode flag is transmitted in the PU or CU level. In another example, the utilized parameters are transmitted in the PU or CU level. The residual compensation process for the equation r_{C}(x, y)=r_{C}′(x, y)+(α×r(x, y)+β) can be conducted for all (x, y) positions of a PU or a CU.

In another example, the residual prediction for intra CU can be still conducted at TU level. However, the residual prediction is conducted at the CU or PU level for Inter CU or Intra block Copy CU.

In yet another example, the mode flag signaling for intra CU is still conducted at TU level. However, the mode flag signaling is conducted at CU or PU level for Inter or Intra block Copy CU.

One or more syntax elements may be used in VPS (video parameter set), SPS (sequence parameter set), PPS (picture parameter set), APS (application parameter set) or slice header to indicate whether the cross-component residual prediction is enabled.

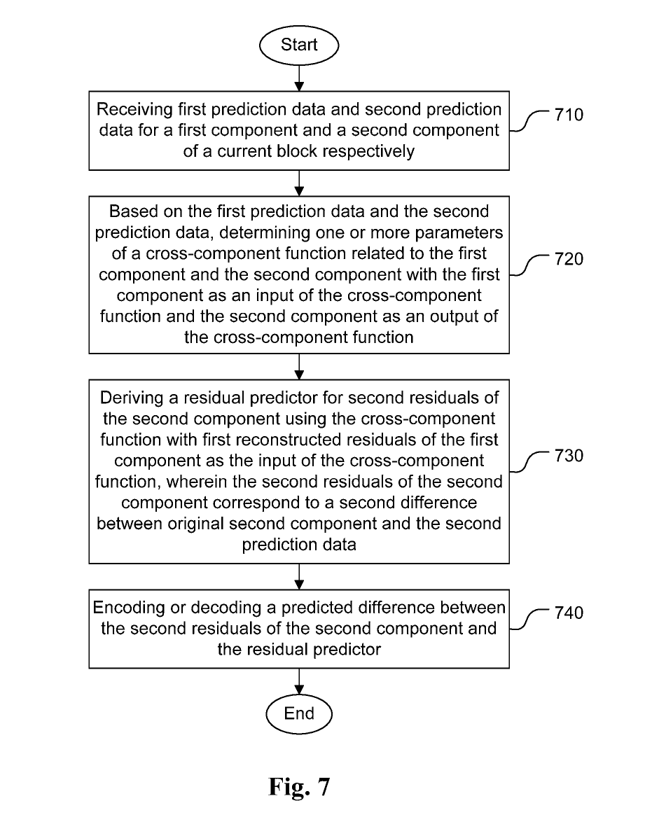

FIG. 7 illustrates an exemplary flowchart for guided cross-component residual prediction incorporating an embodiment of the present invention. The system receives first prediction data and second prediction data for a first component and a second component of a current block respectively in step 710. The first prediction data and second prediction data may be retrieved from storage such as a computer memory of buffer (RAM or DRAM). The reconstructed residuals of the first component may also be received from a processor such as a processing unit or a digital signal. Based on the first prediction data and the second prediction data, one or more parameters of a cross-component function are determined in step 720. The cross-component function is related to the first component and the second component with the first component as an input of the cross-component function and the second component as an output of the cross-component function. A residual predictor is derived for second residuals of the second component using the cross-component function with first reconstructed residuals of the first component as the input of the cross-component function in step 730. The second residuals of the second component correspond to a second difference between original second component and the second prediction data. A predicted difference between the second residuals of the second component and the residual predictor is then encoded or decoded in step 740.

The flowchart shown above is intended to illustrate examples of guided inter-component residual prediction for a video encoder and a decoder incorporating an embodiment of the present invention. A person skilled in the art may modify each step, re-arranges the steps, split a step, or combine the steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of cross-component residual prediction for video data comprising two or more components, the method comprising:
receiving first prediction data and second prediction data for a first component and a second component of a current block respectively;
based on the first prediction data and the second prediction data, determining one or more parameters of a cross-component function related to the first component and the second component with the first component as an input of the cross-component function and the second component as an output of the cross-component function;
deriving a residual predictor for second residuals of the second component using the cross-component function with first reconstructed residuals of the first component as the input of the cross-component function, wherein the second residuals of the second component correspond to a second difference between original second component and the second prediction data; and
encoding or decoding a predicted difference between the second residuals of the second component and the residual predictor.

2. The method of claim 1, wherein the first prediction data and the second prediction data correspond to motion compensation prediction blocks, reconstructed neighboring samples, or reconstructed neighboring residuals of the current block for the first component and the second component respectively.

3. The method of claim 2, wherein the motion compensation prediction blocks of the current block for the first component and the second component correspond to Inter, Inter-view or Intra Block Copy predictors of the current block for the first component and the second component respectively.

4. The method of claim 1, wherein the video data has three components corresponding to YUV, YCrCb or RGB, and the first component and the second component are selected from the three components.

5. The method of claim 4, wherein when the three components correspond to YUV or YCrCb, the first component corresponds to Y and the second component corresponds to one chroma component selected from UV or CrCb, or the first component corresponds to a first chroma component selected from UV or CrCb and the second component corresponds to a second chroma component selected from UV or CrCb respectively.

6. The method of claim 1, wherein the cross-component function is a linear function comprising an alpha parameter or both the alpha parameter and a beta parameter, and wherein the alpha parameter corresponds to a scaling term to multiply with the first component and the beta parameter corresponds to an offset term.

7. The method of claim 6, wherein the alpha parameter, the beta parameter or both the alpha parameter and the beta parameter are determined using a least square procedure based on the cross-component function with the first prediction data as the input of the cross-component function and the second prediction data as the output of the cross-component function.

8. (canceled) .

9. The method of claim 2, wherein the first prediction data is subsampled to a same spatial resolution of the second component if the first component has a higher spatial resolution than the second component.

10. The method of claim 2, wherein the first prediction data and the second prediction data correspond to the reconstructed neighboring samples or the reconstructed neighboring residuals of the current block for the first component and the second component respectively, the first prediction data consists of N first samples and the second prediction data consists of M second samples with M equal to N/2, and an average value of every two reconstructed neighboring samples or reconstructed neighboring residuals of the current block for the first component is used for deriving the alpha parameter, the beta parameter or both of the alpha parameter and the beta parameter.

11. The method of claim 2, wherein the first prediction data and the second prediction data correspond to predicted samples of the motion compensation prediction blocks of the current block for the first component and the second component respectively, the first prediction data consists of N first samples and the second prediction data consists of M second samples with M equal to N/2, and an average value of every two vertical-neighboring predicted samples of the motion compensation prediction block of the current block for the first component is used for deriving the alpha parameter, the beta parameter or both of the alpha parameter and the beta parameter.

12. The method of claim 2, wherein the first prediction data and the second prediction data correspond to predicted samples of the motion compensation prediction blocks of the current block for the first component and the second component respectively, the first prediction data consists of N first samples and the second prediction data consists of M second samples with M equal to N/4, and an average value of left-up and left-down samples of every four-sample cluster of the motion compensation prediction block of the current block for the first component is used for deriving the alpha parameter, the beta parameter or both of the alpha parameter and the beta parameter.

13. The method of claim 6, wherein the first prediction data and the second prediction data correspond to subsampled or filtered motion compensation prediction blocks of the current block for the first component and the second component respectively.

14. The method of claim 6, wherein the alpha parameter, the beta parameter or both the alpha parameter and the beta parameter are determined for each TU (transform unit), each PU (prediction unit) or CU (coding unit).

15. The method of claim 6, wherein the cross-component residual prediction is applied to each TU (transform unit) in each Intra coded CU (coding unit), and applied to each PU (prediction unit) or each CU in each Inter, inter-view or Intra Block Copy coded CU.

16. The method of claim 6, wherein a mode flag to indicate whether to apply the cross-component residual prediction is signaled at TU (transform unit) level for each Intra coded CU (coding unit), and at PU (prediction unit) or CU level for each Inter, inter-view or Intra Block Copy coded CU.

17. The method of claim 1, wherein the first reconstructed residuals of the first component are subsampled before applying the cross-component function to match a spatial resolution of the second component for deriving the residual predictor for the second residuals of the second component if the first component has a higher spatial resolution than the second component.

18. The method of claim 17, wherein the first reconstructed residuals of the first component consist of N first samples and the second residuals of the second component consist of M second samples with M equal to N/4, and an average value of left-up and left-down samples of every four-sample cluster, an average value of every four-sample cluster, an average value of two horizontal neighboring samples of every four-sample cluster or a corner sample of every four-sample cluster of the first reconstructed residuals of the first component is used for the residual predictor.

19. The method of claim 1, wherein the cross-component residual prediction is applied at CTU (coding tree unit), LCU(largest coding unit), CU (coding unit) level, PU (prediction unit) level, or TU (transform unit) level.

20. (canceled)

21. The method of claim 1, wherein a QP (quantization parameter) is selected to code the second residuals of the second component according to whether the cross-component residual prediction is applied.

22. The method of claim 1, wherein one or more syntax elements are used in VPS (video parameter set), SPS (sequence parameter set), PPS (picture parameter set), APS (application parameter set) or slice header to indicate whether the cross-component residual prediction is enabled.
